(19) United States
(12) Patent Application Publication
(10) Pub. No.: US 2019/0050732 A1
(43) Pub. Date: Feb. 14, 2019

(54) DYNAMIC RESPONSIVENESS PREDICTION

(71) Applicant: Intel Corporation, Santa Clara, CA (US)

(72) Inventor: Glen J. Anderson, Beaverton, OR (US)

(21) Appl. No.: 16/115,404

(22) Filed: Aug. 28, 2018

(51) Int. Cl. G06N 3/08; G06N 3/04; G08B 25/00

(52) U.S. Cl. CPC G06N 3/08; G08B 25/001; G06N 3/04

(57) ABSTRACT

A smart space may be any monitored environment, such as a factory, home, office, public or private area inside a structure, or outside (e.g. park, walkway, street, etc.), or on or in a device, transport, or other machine. An Al, e.g. a neural network, may be used to monitor the smart space and predict activity in the smart space. If an incident occurs, such as a machine jam, person falling, etc., and alert may issue and the neural net monitor for agent responsiveness to the incident. If the Al predicts the agent is taking an appropriate response it may clear the alert, otherwise it may further instruct the agent and/or escalate the alert. The Al may analyze visual or other data presenting the smart space to predict activity of agents or machines lacking sensors to directly provide information about activity being performed.

### TECHNICAL FIELD

The present disclosure relates to smart spaces, and more particularly, to an Al assisting with monitoring a smart space in situations where sensors are insufficient or unavailable.

### BACKGROUND AND DESCRIPTION OF RELATED ART

In smart spaces, which can be any environment such as a factory, manufacturing area, home, office, public or private area inside a structure or outside (e.g. in a park, walkway, street, etc.), as well as on or in a device, smart transport device, or relating to a device, it may be useful to monitor and predict the activity of people and other agents, such as automation devices, transportation devices, smart transport devices, equipment, robots, automatons, or other devices. It would be useful to know if and when something (a person and/or equipment), e.g., a “responder”, is responding to an issue, condition or directive (e.g., a directive relating to or responsive to an issue or condition), hereafter “event”, or if and when a responder may be using or about to use an item in the smart space. For example, machines may be powered down or idled when not in use and unlikely to be used, or when an incident, accident or other situation suggests a need to change a machine's operational state.

In existing smart spaces, a smart space may contain sensors that can detect movement or approach of a responder to an event, but thresholds of distance for each object or item related to the event has to be determined through human analysis and software settings to represent what is a valid response. Further, everything to be tracked needs a sensor and connectivity. Local sensors can detect, for example, the approach of people. If sensors are embedded throughout an environment and within every item that might have a problem, then it may be possible to determine that a responder responded to the event and by way of a sensor no longer reporting the event, it may be assumed the responder resolved the event. However, as noted, it is required to define, for every event, all possible responders and sensors that need to be used to determine if a response is occurring or has occurred, and sensors must be employed to determine the event is no longer occurring.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an exemplary smart space environment 100 and monitoring Al, according to various embodiments.

FIG. 2 illustrates an exemplary flowchart for establishing an Al and the Al monitoring a smart space, according to various embodiments.

FIG. 3 illustrates an exemplary system 300, according to various embodiments.

FIG. 4 illustrates an exemplary system including smart transport device incident management, which may operate in accordance with various embodiments.

FIG. 5 illustrates an exemplary neural network, according to various embodiments.

FIG. 6 illustrates an exemplary software component view of a smart transport device incident management system, according to various embodiments.

FIG. 7 illustrates an exemplary hardware component view of a smart transport device incident management system, according to various embodiments.

FIG. 8 illustrates an exemplary computer device 800 that may employ aspects of the apparatuses and/or methods described herein.

FIG. 9 illustrates an exemplary computer-readable storage medium 900 having instructions for practicing various embodiments discussed herein.

### DETAILED DESCRIPTION

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations do not have to be performed in the order of presentation. Operations described may be performed in a different order than the described embodiment. Various additional operations may be performed and/or described operations may be omitted in additional embodiments. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are considered synonymous.

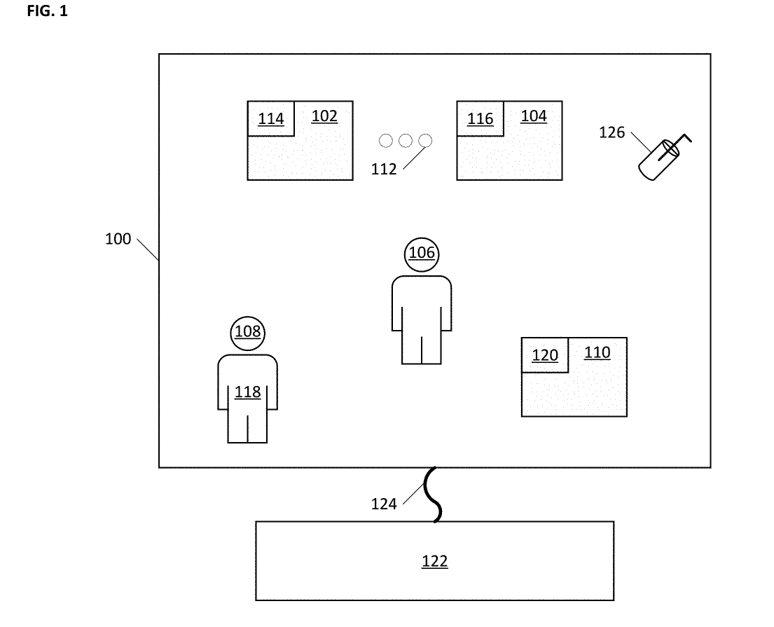

FIG. 1 illustrates an exemplary smart space environment 100 and monitoring Al, according to various embodiments including items 102-110, sensors 114-120 monitoring the items, and an Al 124 associated 126 with the smart space. It will be appreciated an item or items 102-110 may represent any event, occurrence, situation, thing, person, problem, etc. that may be identified. Ellipses 112 indicate illustrated items are exemplary and there may be many more items in the smart space. An item may be tangible, such as a machine 102 needing attention, goods 104 stacked and waiting for processing, shipping, etc., or a person 106, 108, or a device 110 such as a conveyor belt that may be used to work on items such as the goods 104. An item may also be intangible such as a situation to be resolved. For example, if someone, such as person 106 fell in the factory or in a park, a response needs to be made to address the fall and an intangible item may represent the desire for a response to the fall. An intangible item may include a constraint set or dependency list needing to be satisfied that corresponds to a proper response to an item such as the fall.

In this embodiment the term “item” is used to cover both tangible and intangible things that may or may not have sensors 114-120 indicating a state or status of the item. For items lacking sensors indicating operational state or status, such as person 106, or items lacking sensors relevant to an intangible item such as a problem to be resolved, an Artificial Intelligence (Al) 122 associated 124 with the smart space 100 may be used to monitor and/or evaluate the smart space, and any items within the smart space and determine information for which sensors are lacking. The term Al is intended to generally refer to any machine based reasoning system, including but not limited to examples such as machine learning, expert systems, automated reasoning, intelligent retrieval, fuzzy logic processing, knowledge engineering, neural networks, natural language processors, robotics, deep learning, hierarchical learning, visual processing, etc.

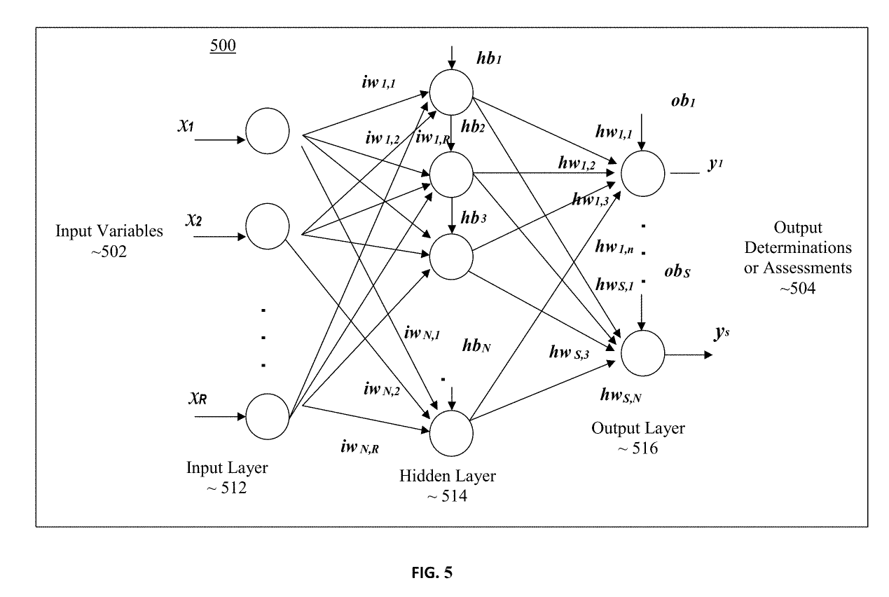

In various discussion of Al herein, it is assumed one is familiar with Al, neural networks, such as feedforward neural network (FNN), convolutional neural network (CNN), deep learning, and establishing an Al, a model and its operation. See the discussion below with respect to FIG. 5. And, see also exemplary documents: Deep Learning by Goodfellow et al., MIT Press (2016) (at Internet Uniform Resource Locator (URL) www*deeplearningbook*org); www*matthewzeiler*com/wp-content/uploads/2017/07/arxive2013*pdf; Dynamic Occupancy Grid Prediction for Urban Autonomous Driving: A Deep Learning Approach with Fully Automatic Labeling, Hoerman et al. 2017, at Internet URL arxiv.org/abs/1705.08781v2; and Nuss et al. 2016, A Random Finite Set Approach for Dynamic Occupancy Grid Maps with Real-Time Application at Internet URL arxiv*org/abs/1605*02406 (to prevent inadvertent hyperlinks, periods in the preceding URLs were replaced with asterisks).

In one embodiment the Al is a software implementation operating within another device, system, item, etc. in the smart space. In another embodiment the Al is disposed in a separate machine that is communicatively coupled with the smart space. In a further embodiment, the Al is disposed in a mobile computing platform, such as a smart transport device, and may be referred to as a “robot” that may traverse within and outside of the smart space. It will be appreciated a smart transport device, robot, or other mobile machine may be mobile by way of one or more combinations of ambulatory (walking-type) motion, rolling, treads, tracks, wires, magnetic movement/levitation, flying, etc.

In one embodiment, an Al may be used to monitor a smart space and/or predict agent actions and item interaction based on monitored movement within the space as well as sensors associated with the space and/or item(s). In one embodiment, a dynamic occupancy grid (DOG) may be used to train a deep CNN to facilitate predicting human and machine interaction with items, e.g., objects, and locations. It will be appreciated that a CNN type of neural network is one that may be particularly effective with data that has a grid-like format, e.g., the pixels that may be output from a monitoring device (see monitoring device 126 discussion below). The CNN may intermittently, or continuously, monitor the smart space and learn patterns of activity, and in particular, learn typical responses and/or actions that may occur responsive to events occurring in the smart space. It will be appreciated a CNN is presented for exemplary purposes, and as discussed with FIG. 5, other types of Al and/or neural-networks may be used to provide predictive abilities, such as predicting movement of independent agents through a monitored environment.

In one embodiment, responses may include activation of items, changes in status for sensors, as well as movement of objects/people/etc. that do not have sensors but that may be identified by way of one or more monitoring devices. In one embodiment, the Al may use unsupervised deep-learning (with automatic labeling or no labeling), where the Al may train itself by observing interactions within the space, e.g., monitoring agent contact with items, actuation of a device (which is an item), user interaction with an item, device activation. It will be appreciated that items (such as IoT devices) may have embedded and/or associated sensors, such as sensors 114-120, which may return data regarding item status, usage, activity, problems, etc. For tangible items lacking sensors or where sensors are unable to provide enough information or are lacking such as for an intangible item, the Al may provide data based at least in part on its monitoring of the smart space.

It will be appreciated by one skilled in the art that the Al 122 may apply probabilistic reasoning models or other techniques to model and analyze a smart space and events occurring therein. It will be further appreciated that while the Al implementation may be unsupervised and self-learning, in other embodiments the Al may be trained, e.g., by backpropagation or other technique, to give the Al a starting context for recognizing typical items in the smart space and facilitate identifying items that are new to the smart space. Item recognition training may include linking recognition to data from sensors, such as in IoT devices within the smart space, as well as based on or at least in part on visual input. While monitoring an environment, regardless of whether the Al was trained or self-taught, the Al may continue to monitor the environment (e.g., the smart space) and learn typical activities that occur within the smart space and therefore be able to identify responses to events within the smart space. This also enables the Al to evaluate (e.g. predict) whether activity within a smart space corresponds to an appropriate response to an item (e.g., some event that has happened in the smart space). If the Al predicts response to an event/problem/item/etc. is not being resolved, or is not being addressed in an appropriate way, the Al may take action. It assumed one skilled in the art understands training and operation of a neural net, such as the exemplary deep learning CNN referenced herein, and therefore operation of the environment is discussed and not how the Al is constructed and trained.

Thus, for example, in the falling person situation mentioned above, when the person (item 106) falls, an Al 122 that has been monitoring with a device 126 (or devices), such as one or more cameras, field, beam, LiDAR (an acronym used to refer to Light Detection and Ranging technology), or other sensor technology allowing forming an electronic representation of an area of interest such as the smart space. It will be appreciated that these listed monitoring devices are for exemplary purposes and that there are many different technologies that may be used individually or in combination with other technology to provide the Al with data corresponding to an area of interest such as the smart space. It will be further appreciated the monitor device 126 may correspond to machine based vision if the Al is incorporated within a robot. And a robot may be independent of the smart space or cooperatively execute and/or cooperatively perform actions in conjunction with the smart space. In one embodiment, even though the person 106 appears to have no associated sensors to directly indicate the status of the item/person, the Al, by monitoring activity in the smart space, may identify the fall and then look for and/or initiate a response to the fall, as well as monitor for an effective response to the event. It will be appreciated the Al may learn that when there is a fall, another person (item 108) should go to, and help, the fallen item/person 106.

It will be appreciated responsive to the fall an item (task list, requirements list, etc.) concerning the fall may be created with a list of actions to take, such as:
issue an alert (e.g., on a local messaging or communication system, flashing lights, text broadcast, voice alert, etc.) to possible responders that a person 106 has fallen;
monitor, e.g., with sensors 114-120, device(s) 126, for response(s) to the fall;
evaluate whether the response is effective and/or an appropriate response;
if so, e.g. someone has gone to the fallen person to assist, then clear the alert; and
if no appropriate response identified, take further/other action such as escalating.

It will be understood a list may imply an order to performing operations but operations may be performed in parallel or in any order, unless there is an operational dependency in operations to be performed. It will be appreciated escalation may be any action to further getting an appropriate response to the event, such as increasing the scope of items contacted about the event, such as to make a general broadcast for help when initially only designated responders were identified, or to contact people proximate to the fallen person even if they are not a typical responder, or to call in third-party help (e.g., emergency services, ambulance, fire department, etc.). In the illustrated embodiment, the responder 108 may be wearing one or more sensor 118 allowing a more direct interaction with the person, and determination that the person is going to or toward the fallen person 106. Sensor 118 may be provide biometric, location, and/or other data about the person. The Al may also watch for and/or initiate a response to any issues that the sensor 118 may indicate, as well as monitor and determine an issue not being indicated by the sensor 118.

In another example, an item 110 may be a conveyor belt and an embedded or associated sensor 120 may indicate a jam that has stopped operation of the belt. The Al may recognize the jam, and through experience (e.g. monitoring/training/learning) understand an alert, message, call, etc. is to be made to a technician, e.g., person 106, who is dispatched to the conveyor belt to fix it. As with the fall example the jam may trigger creating an intangible item corresponding to the problem and potential solution paths for resolving the issue the Al may monitor for a solution, e.g., an approach of the technician person 106 and if this is not occurring the Al may take action to facilitate the solution, such as by sending out other alerts, contacting backup technicians, sounding an alarm, etc. As noted above, in one embodiment an intangible item may refer to, for example, an abstract description of a situation or a problem; it will be appreciated an intangible item may be a reference, list, constraint set, rule set, requirements, etc. relating to one or more interactions between tangible items, e.g., automatons, people, drones, robots, bots or swarms with limited power or limited or no network access, etc. By introducing an Al into monitoring and resolution processes for managing tangible and/or intangible items, it becomes feasible to determine whether resolution is occurring for items even if the resolution require intervention by or engagement with items, entities, third-parties, etc. that lack sensors to directly indicate actions that are occurring, such as a Good Samaritan, ambulance, emergency services, police, other responder etc. helping out with a problem.

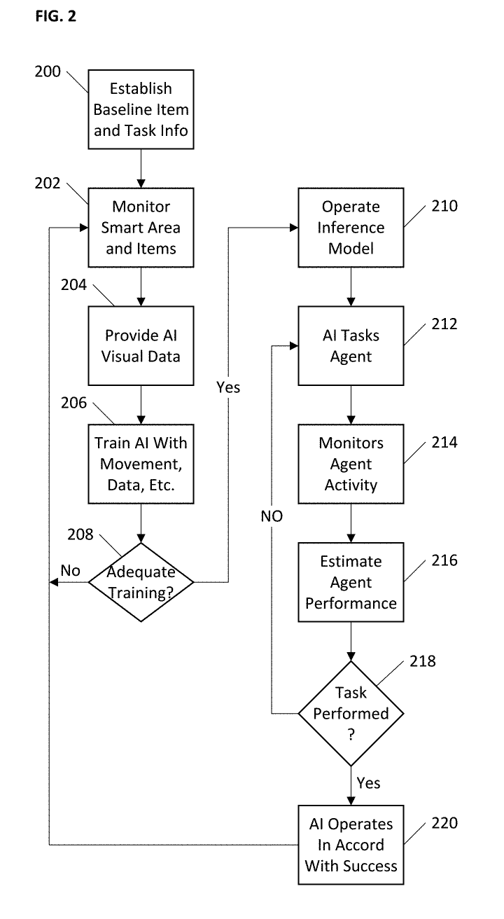

FIG. 2 illustrates an exemplary flowchart for establishing an Al and the Al monitoring a smart space, according to various embodiments. Let's assume a situation in the smart space where a sensor detected an object jamming a production line, and based on machine vision and/or other input providing information to the Al about activity in the smart space, the Al could issue/repeat an alert, for example, an audio message to agents to unjam it. In one embodiment, the information provided to the Al may be direct, e.g., visual-type data such as from a monitor 126 or eyesight system (not illustrated), and/or indirect data, e.g., from inferences derived from visual-type data and/or extrapolation from sensor data regarding the smart space and accessible to the Al. At a high level, it will be appreciated an agent (employee, bystander, Good Samaritan, etc.) may be detected as moving toward the location of the jam, and the Al may predict (for example, based on a model developed for operation of the smart space) whether the agent is on the way to the problem (or taking some other movement) based on its machine learning from previous observations.

Thus if the Al determines the agent is moving toward the problem it can stop an alert at least until the Al possibly determines that no solution is at hand in which case it may re-introduce an alert and/or escalate the alert. It will be appreciated such prediction may apply to any interaction with an item, e.g., any object, device, task location, or intangible item known to the Al. It will be appreciated an Al monitoring for agent responsiveness to an issue and cancelling an alert as discussed facilitates efficient (e.g., not sending too many agents) responsiveness, while also facilitating continued Al training based on the effectiveness or lack thereof in a response. In the illustrated embodiment, a database for the Al is established 200 with some baseline data about the environment, such as identifying items and their location in the smart space, associating items and tasks, etc. as such information may help the Al understand various aspects of the smart space. This may be performed as part of backpropagation training of the Al. It will be appreciated preliminary population of a database could be skipped and expect the Al to simply monitor 202 everything occurring in the smart space and automatically train itself based on observation of activity, including receiving data from sensors, if any, monitoring agent movement, etc. coming and going. In one embodiment the agent may be in the smart space discussed above, however it will be appreciated the embodiments disclosed herein apply to any environment for which a predictive model may be developed. For example the agent may be in a factory, kitchen, hospital, park, playground, or any other environment that may be mapped. A map may be derived by combining observation data with other data to determine coordinates within the environment and cross-reference spatial information with items within the environment.

As discussed in FIG. 1 the Al may monitor the smart space with, for example, a device 126 such as a camera. Monitored audio, video (e.g., showing agent movement), sensor data, or other data may be provided to the Al. In one embodiment at least the Al is provided 204 visual data. The Al will analyze the data and use it to update its model for the smart space. In one embodiment, the Al employs a CNN, and while monitoring 202 it is understood the Al is reviewing available visual information (e.g., a 2D pixel representation such as a photo), and processes it to determine what is occurring within it, e.g., the Al convolves features against the entire image, pools data to reduce complexity requirements, rectifies and repeats convolution/rectification/pooling as is treated as multiple layers of processing that results in increasingly feature-filtered output.

As will be appreciated by one skilled in the art, other processing occurs as well, and all the different layers may be processed to determine what is occurring in an image or video. In one embodiment, the Al uses dynamic occupancy grid maps (DOGMa) that are used to train deep CNNs. These CNN provide for predicting activity over periods of time, e.g., predicting up to 3 seconds (and more depending on design) of movement from smart transport devices, e.g., vehicles, and pedestrians in crowded environments. In one embodiment, for processing efficiency, existing techniques for grid cell filtering may be used. For example, instead of following a full point cloud in each grid, representative pixels in each cell of tracked objects are chosen by various methods, e.g., sequential Monte Carlo or Bernoulli filtering.

After establishing 200 baseline data and beginning to monitor 202 the smart space, as discussed above the Al is provided 204 at least the visual data associated with the monitoring. As will be appreciated the processing of data will train 206 the Al with a better understanding of what occurs in the smart space. It will be understood that while the illustrated flowchart is linear, the Al operations, such as the training 206, itself represent looping activity that is not illustrated but that continues to refine the model the Al has for the smart space. A test may be performed to determine if 208 the training is adequate. It will be understood that Al training may use backpropagation to identify content to the Al, and may form a part of the baseline establishment 200 process, and it may be performed later, such as if training is not yet adequate. Typically backpropagation requires manual, e.g., human, intervention to tell the Al what certain input means/is, and this may be used to refine the model the Al develops so that it may better understand what it later receives as input. In one embodiment, the Al is auto-learning and self-correcting/self-updating the model. The Al may monitor the smart space and it will recognize patterns of activity in the smart space. Since the smart space, and other defined areas tend to have an overall organization of activity/functions that happen in the space, that fundamental organizational pattern will emerge in the model. The Al predicts what it expects to occur next and the accuracy of the predictions will allow at least in part determining whether enough data is known. If 208 training is not yet accurate enough, processing may loop back to monitoring 202 the smart area and learning typical activity.

If 208 the training is accurate enough, then the inference model is operated 210, and at some point, the Al recognizes a problem. For example, a more directly sensed problem is the object jam example from above, where a sensor associated with the impacted item indicates a problem and the Al monitors for responses to the problem, or the Al may recognize the fall example by way of at least the visual data such as from FIG. 1 item 126 monitor. After the model identifies a problem, the Al may task 212 an agent to address the problem, for example to issue an alert, announcement, text message, or other data to cause one or more agent to address the problem. Agents could include people, robots, cars, or any autonomous or semi-autonomous agent or group or combination. Items of interest, e.g., objects or areas of interest, could include objects, other people, equipment, a spill, an unknown event (as sensed contextually by deviations from the usual) etc. Actions of an agent may be application specific but could include any activity requiring proximity of the agent to the target object or area.

The Al continues to monitor the space and in particular monitors 214 the agent activity. It will be appreciated based at least in part on the monitoring the Al estimates 216 the agent's performance in responding to the problem. With the inference model the Al may identify whether the monitored activity corresponds to activity toward a solution for the monitored problem.

In a simplistic solution example, the Al may monitor for an agent to move proximate to the problem being solved. For complex problems the Al may have determined that one or more agents and/or items are used to resolve the problem. By applying an Al such as one based at least in part on a CNN implementation allowing predicting agent action over periods of time, it is possible to recognize activity of agents that do not have sensors but take action that may be seen as complying with predicted activity necessary to resolving a problem. And these predictions, as discussed above, may be combined with IoT devices and/or sensors that in combination allow for a flexibility in monitoring the smart space.

If 218 the Al determines an appropriate response has been made, then the Al may operate 220 in accord with a successful resolution to the problem, e.g., the Al may clear the alert and/or perform other actions, such as to identify to other agents/devices/sirens/etc. that the problem is resolved and processing continues with monitoring 202 the smart space. If 218 however (and there is an implied delay not illustrated to allow a response to occur) there has not been a recognized performance of the task, then processing may loop back to tasking 212 an agent (the same or another if the first agent did respond but did not resolve the problem) with resolving the problem. It is worth noting that while this flowchart presents a sequential series of operations it will be appreciated that in fact an operational thread/slice of awareness may be tasked with the problem and resolution thereto, while the Al in parallel continues with monitoring the smart space and taking other action.

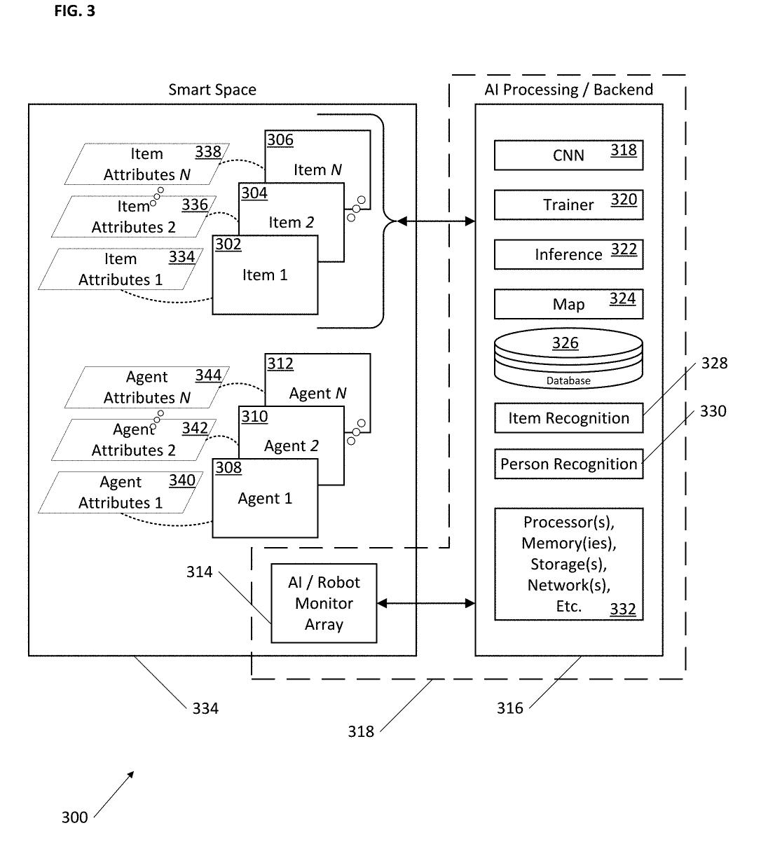

FIG. 3 illustrates an exemplary system 300, according to various embodiments illustrating items 302-306 and agents 308-312 that may operate, in conjunction with an Al 314, in accord with some embodiments. As illustrated, different modules may be operate within the monitoring area of an Al. As discussed above the Al may track multiple tangible and/or intangible items 302-306. It will be appreciated the ellipses indicate there may be many items. Three are shown for illustration convenience only. The Al may also monitor and track activity of agents 308-312. As with the items there may be many agents, that may include, for example, employees, smart devices, robots, etc. associated with a smart space 334, as well as third-parties, bystanders, etc. that may be inside or outside a smart space but not necessarily directly related, such as delivery personnel, first responders, Good Samaritans, bystanders, etc.

In the illustrated embodiment, the items and agents 302-312 correspond to the items 102, 104, 110 and people 106-108 of FIG. 1 and the interaction between the items and agents with the Al may occur as described with respect to FIGS. 1-2. There may be an Al monitoring array 314 that is monitoring the items and agents and identifying situations that may require resolution, and predicting whether an appropriate response occurs. In the illustrated embodiment, the Al monitoring array may be disposed, for example, in a robot or other mobile machine, such as a smart transport that may move about a smart space 334 or other environment. It will be appreciated that while a smart space provides for a controlled environment more accessible to self-teaching an Al, the Al and the teachings herein may be disposed in one or more smart transport devices that move about, such as on roads or flying through airspace.

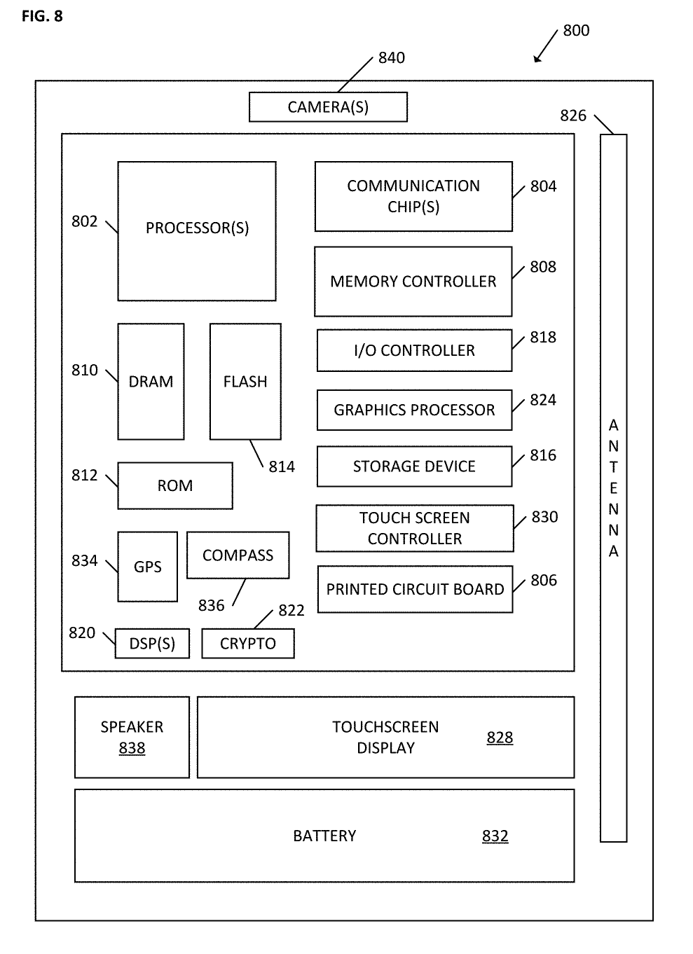

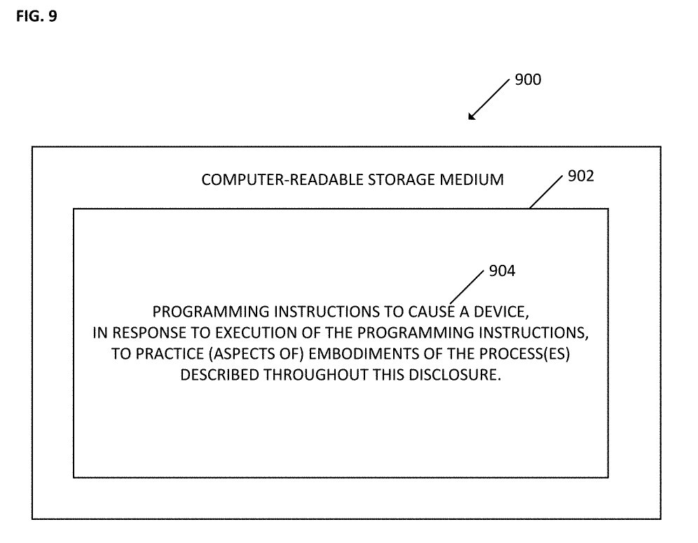

The Al 314 may be in communication with an Al Processing/Backend 316 which is shown with exemplary components to support operation of an Al/neural net. The Backend may, for example, contain a CNN 318 (or other neural network) component, a Trainer 320 component, an Inference 322 component, a Map 324 component, an item (or other information storage) database 326 component, an Item Recognition 328 component, and a Person Recognition 330 component. It will be appreciated, as discussed with respect to FIG. 9, components 318-330 may be implemented in hardware and/or software. The backend may contain other conventional components 332 such as one or more processor, memory, storage (which may include database 326 component or be separate), network connectivity, etc. See FIG. 8 discussion for a more complete description of an environment that may in part be used to implement the Backend.

In the illustrated embodiment, the items and agents 302-312 may have associated attributes 334-344. These attributes may be stored within an item if, for example, the item is an Internet of Things (IoT) device with a local memory for storing its state and/or other data. For other items, such as intangible items, the data may be tracked by the Al 314 and stored, for example, in the memory of item 332. Regarding the agents 308-312, an agent 308 may be an employee or otherwise working with the smart space 334. As shown the Al 314 may be operating partially within the smart space, with a separate and possibly remote Backend 316. However, it will be appreciated the Al and Backend may be co-located and/or disposed into a single environment 318 represented by the dashed line as one possible configuration. The co-located environment may, for example, be within the smart space. In one embodiment, some functions, such as the monitoring of the smart space 334 may be performed by the Al monitor array 314, but where more complex analysis, e.g., “heavy lifting” tasks, such as item recognition 328 and Person Recognition 330, may be performed on the Backend 316 hardware. It will be appreciated that although the Backend is presented as a single entity, it may be implemented with a set (not illustrated) of cooperatively executing servers, machines, devices, etc.

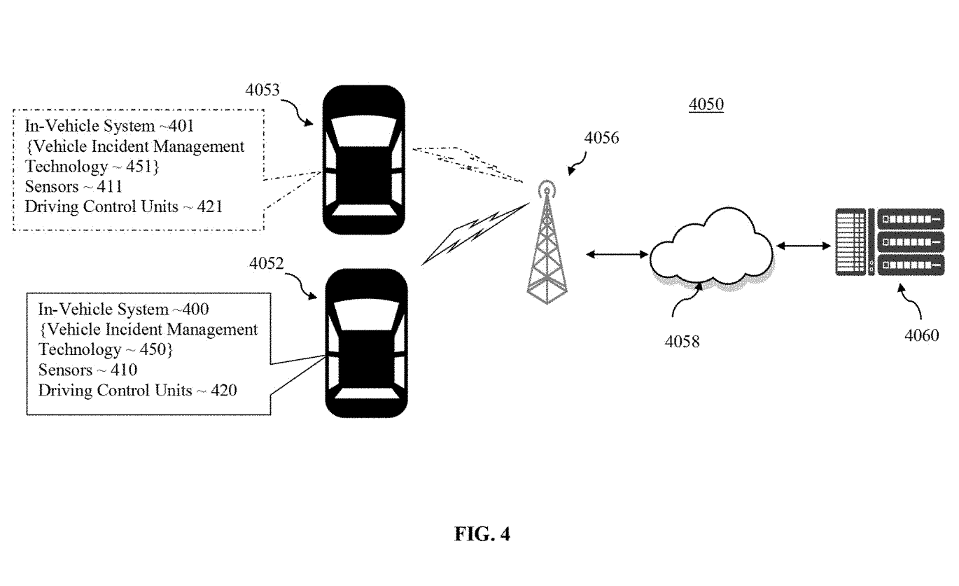

FIG. 4 illustrates an exemplary system including smart transport device incident management, which may operate in accordance with various embodiments. The illustrated embodiment provides for incorporating and using smart transport device incident management in conjunction with various embodiments. As shown, for the illustrated embodiments, example environment 4050 includes smart transport device 4052 having an engine, transmission, axles, wheels and so forth. Further, smart transport device 4052 includes internal infotainment (IVI) system 400 having a number of infotainment subsystems/applications, e.g., instrument cluster subsystem/applications, front-seat infotainment subsystem/application, such as, a navigation subsystem/application, a media subsystem/application, a smart transport device status subsystem/application and so forth, and a number of rear seat entertainment subsystems/applications. Further, IVI system 400 is provided with smart transport device vehicle incident management (VIM) system/technology 450 of the present disclosure, to provide smart transport device 4052 with computer-assisted or autonomous management of a smart transport device incident smart transport device 4052 is involved in. It will be appreciated the FIG. 1 Al 122 may be disposed within one or more of the smart transport devices, or be in communication with and/or in control of and/or directing the smart transport devices. The smart transport device incident smart transport device may be part of a response to an issue, problem, accident, etc. in the smart environment.

A smart transport device 4052 may be associated with an incident, such as an accident, that may or may not involve another smart transport device, such as smart transport device 4053 and smart transport device 4052 may cooperatively operate with, for example, FIG. 1 agents 106, 108. In an incident not involving another smart transport device, smart transport device 4052 may have a flat tire, hit a barrier, slid off the roadway, and so forth. In incidents involving another smart transport device, smart transport device 4052 may have a rear-end collision with another smart transport device 4053, head-to-head collision with the other smart transport device 4053 or T-boned the other smart transport device 4053 (or by the other smart transport device 4053). The other smart transport device 4053 may or may not be equipped with internal system 401 having similar smart transport device incident management technology 451 of the present disclosure. In one embodiment, a smart transport device may be considered a smart space being monitored by an Al including the incident management technology.

In some embodiments, VIM system 450/451 is configured to determine whether smart transport device 4052/4053 is involved in a smart transport device incident, and if smart transport device 4052/4053 is determined to be involved in an incident, whether another smart transport device 4053/4052 is involved; and if another smart transport device 4053/4052 is involved, whether the other smart transport device 4053/4052 is equipped to exchange incident information. Further, VIM system 450/451 is configured to exchange incident information with the other smart transport device 4053/4052, on determination that smart transport device 4052/4053 is involved in a smart transport device incident involving another smart transport device 4053/4052, and the other smart transport device 4053/4052 is equipped to exchange incident information. In one embodiment, if it is determined a smart transport device 4052/4053 had an accident within a smart space such as within FIG. 1 smart space 100, the smart transport device 4052/4053 is equipped to exchange incident information with the smart space. The Al may instruct the smart transport device regarding what to do next.

In some embodiments, VIM system 450/451 is further configured to individually assess one or more occupants' and/or bystander (which may be involved in the accident, witness to the accident, etc.) respective physical or emotional conditions, on determination that smart transport device 4052/4053 is involved in a smart transport device incident. Each occupant being assessed may be a driver or a passenger of smart transport device 4052/4053. For examples, each occupant and/or bystander may be assessed to determine if the occupant and/or bystander is critically injured and stressed, moderately injured and/or stressed, minor injuries but stressed, minor injuries and not stressed, or not injured and not stressed. In some embodiments, VIM system 450/451 is further configured to assess the smart transport device's condition, on determination that the smart transport device 4052/4053 is involved in a smart transport device incident. For examples, the smart transport device may be assessed to determine is severely damaged and not operable, moderately damaged but not operable, moderately damaged but operable, or minor damages and operable. In some embodiments, VIM system 450/451 is further configured to assess condition of an area surrounding smart transport device 4052/4053, on determination that smart transport device 4052/4053 is involved in a smart transport device incident. For examples, the area surrounding smart transport device 4052/4053 may be assessed to determine whether there is a safe shoulder area for smart transport device 4052/4053 to safely move to, if smart transport device 4052/4053 is operable.

Still referring to FIG. 4, smart transport device 4052, and smart transport device 4053, if involved, may include sensors 410 and 411, and driving control units 420 and 421. In some embodiments, sensors 410/411 are configured to provide various sensor data to VIM 450/451 to enable VIM 450/451 to determine whether smart transport device 4052/4053 is involved in a smart transport device incident; if so, whether another smart transport device 4053/4052 is involved; assess an occupant's condition; assess the smart transport device's condition; and/or assess the surrounding area's condition. In some embodiments, sensors 410/411 may include cameras (outward facing as well as inward facing), light detection and ranging (LiDAR) sensors, microphones, accelerometers, gyroscopes, inertia measurement units (IMU), engine sensors, drive train sensors, tire pressure sensors, and so forth. Driving control units 420/421 may include electronic control units (ECUs) that control the operation of the engine, the transmission the steering, and/or braking of smart transport device 4052/4053. It will be appreciated while the present disclosure refers to smart transport devices, the present disclosure is intended to include any transportation device, including automobile, train, bus, tram, or any mobile device or machine including machines operating within a FIG. 1 smart space 100, such as forklifts, carts, transports, conveyors, etc.

In some embodiments, VIM system 450/451 is further configured to determine, independently and/or in combination with the FIG. 1 Al 122, an occupant caring action or a smart transport device action, based at least in part on the assessment(s) of the occupant(s) condition, the assessment of the smart transport device's condition, the assessment of a surrounding area's condition, and/or information exchanged with the other smart transport device. For examples, the occupant and/or smart transport device caring actions may include immediately driving the occupant(s) to a nearby hospital, coordinating with an emergency responder or other person, e.g., FIG. 1 people 106, 108, moving the smart transport device to a shoulder of the roadway or specific location in a smart space, and so forth. In some embodiments, VIM 450/451 may issue, or cause to be issued, or receive from an Al 122, driving commands, to driving control units 420/421 to move smart transport device 4052/4053 to effectuate or contribute to effectuating the occupant or smart transport device care action.

In some embodiments, IVI system 400, on its own or in response to the user interactions, or Al 122 interaction, may communicate or interact with one or more remote content servers 4060 external to the smart transport device, via a wireless signal repeater or base station on transmission tower 4056 near smart transport device 4052, and one or more private and/or public wired and/or wireless networks 4058. Servers 4060 may be servers associated with the insurance companies providing insurance for smart transport devices 4052/4053, servers associated with law enforcement, or third party servers who provide smart transport device incident related services, such as forwarding reports/information to insurance companies, repair shops, and so forth. Examples of private and/or public wired and/or wireless networks 4058 may include the Internet, the network of a cellular service provider, networks within a smart space, and so forth. It is to be understood that transmission tower 4056 may be different towers at different times/locations, as smart transport device 4052/4053 is on its way to its destination. For the purpose of this specification, smart transport devices 4052 and 4053 may be referred to as smart transport device incident smart smart transport devices, or smart transport devices.

FIG. 5 illustrates an exemplary neural network, according to various embodiments. As illustrated, the neural network 500 may be a multilayer feedforward neural network (FNN) comprising an input layer 512, one or more hidden layers 514 and an output layer 516. Input layer 512 receives data of input variables (xᵢ) 502. It will be appreciated an Artificial Neural Network (ANN) is based on connections between interconnected “neurons” stacked in layers. In a FNN, data moves in one direction, without cycles or loops, where data may move from input nodes, though hidden nodes (if any), and then to output nodes. The Convolutional Neural Network (CNN) discussed above with respect to operation of the FIG. 1 Al 122 is a type of FNN that works well, as discussed, with processing visual data such as video, images, etc.

Hidden layer(s) 514 processes the inputs, and eventually, output layer 516 outputs the determinations or assessments (yᵢ) 504. In one example implementation the input variables (xᵢ) 502 of the neural network are set as a vector containing the relevant variable data, while the output determination or assessment (yᵢ) 504 of the neural network are also as a vector. A Multilayer FNN may be expressed through the following equations:

hoᵢ=f(Σⱼ₌₁^{R}(iw_{i,j}xⱼ)+hbᵢ), for i=1, . . . ,N

yᵢ=f(Σₖ₌₁^{N}(hw_{i,k}hoₖ)+obᵢ), for i=1, . . . ,S

where hoᵢ and yᵢ are the hidden layer variables and the final outputs, respectively. f( ) is typically a non-linear function, such as the sigmoid function or rectified linear (ReLu) function that mimics the neurons of the human brain. R is the number of inputs. N is the size of the hidden layer, or the number of neurons. S is the number of the outputs. The goal of the FNN is to minimize an error function E between the network outputs and the desired targets, by adapting the network variables iw, hw, hb, and ob, via training, as follows:

E=Eₖ₌₁^{m}(Eₖ), where Eₚ₌₁^{s}(tₖₚ=yₖₚ)²

where yₖₚ and tₖₚ are the predicted and the target values of pth output unit for sample k, respectively, and m is the number of samples.

In some embodiments, and as discussed with respect to FIG. 2, an environment implementing the FNN, such as FIG. 3 Al processing backend 316, may include a pre-trained neural network 500 to determine whether a smart transport device, such as a vehicle, is not involved in an incident or accident, involved in an incident or accident without another smart transport device, or involved in an incident or accident with at least one other smart transport device, such as an accident between two vehicles. The input variables (xᵢ) 502 may include objects recognized from the images of the outward facing cameras, and the readings of the various smart transport device sensors, such as accelerometer, gyroscopes, IMU, and so forth. The output variables (yᵢ) 504 may include values indicating true or false for smart transport device not involved in an incident or accident, smart transport device involved in an incident or accident not involving another smart transport device and smart transport device involved in an incident or accident involving at least one other smart transport device, such as a vehicle. The network variables of the hidden layer(s) for the neural network for determining whether the smart transport device is involved in an incident, and whether another smart transport device is involved, are determined at least in part by the training data. In one embodiment, the FNN may be fully or partially self-training through monitoring and automatic identification of events.

In one embodiment, the smart transport device includes an occupant assessment subsystem (see, e.g., FIG. 4 discussion) that may include a pre-trained neural network 500 to assess condition of an occupant. The input variables (xᵢ) 502 may include objects recognized in images of the inward looking cameras of the smart transport device, sensor data, such as heart rate, GSR readings from sensors on mobile or wearable devices carried or worn by the occupant. The input variables may also include information derived by an Al such from a FIG. 2 Al monitoring 202 a smart space as discussed above. It will be understood the smart transport device may have associated therewith the neural network 500 operating in conjunction with or independent of an Al associated with a smart space. The output variables (yᵢ) 504 may include values indicating selection or non-selection of a condition level, from healthy, moderately injured to severely injured. The network variables of the hidden layer(s) for the neural network of occupant assessment subsystem may be determined by the training data.

In some embodiments, a smart transport device assessment subsystem may include a trained neural network 500 to assess condition of the smart transport device. The input variables (xᵢ) 502 may include objects recognized in images of the outward looking cameras of the smart transport device, sensor data, such as deceleration data, impact data, engine data, drive train data and so forth. The input variables may also include data received from an Al such as FIG. 1 Al 122 that may be monitoring the smart transport device and thus have assessment data that may be provided to the smart transport device. The output variables (yᵢ) 504 may include values indicating selection or non-selection of a condition level, from fully operational, partially operational to non-operational. The network variables of the hidden layer(s) for the neural network of smart transport device assessment subsystem may be, at least in part, determined by the training data.

In some embodiments, external environment assessment subsystem may include a trained neural network 500 to assess condition of the immediate surrounding area of the smart transport device. The input variables (xᵢ) 502 may include objects recognized in images of the outward looking cameras of the smart transport device, sensor data, such as temperature, humidity, precipitation, sunlight, and so forth. The output variables (yᵢ) 504 may include values indicating selection or non-selection of a condition level, from sunny and no precipitation, cloudy and no precipitation, light precipitation, moderate precipitation, and heavy precipitation. The network variables of the hidden layer(s) for the neural network of external environment assessment subsystem are determined by the training data.

In some embodiments, the environment providing the FNN may further include another trained neural network 500 to determine an occupant/smart transport device care action. Action may be determined autonomously and/or in conjunction with operation of another Al, such as when operating within a smart space monitored by the other Al. The input variables (xᵢ) 502 may include various occupant assessment metrics, various smart transport device assessment metrics and various external environment assessment metrics. The output variables (yᵢ) 504 may include values indicating selection or selection for various occupant/smart transport device care actions, e.g., drive occupant to nearby hospital, move smart transport device to roadside and summon first responders, stay in place and summon first responders, or continue onto repair shop or destination. Similarly, the network variables of the hidden layer(s) for the neural network for determining occupant and/or smart transport device care action are also determined by the training data. As illustrated in FIG. 5, for simplicity of illustration, there is only one hidden layer in the neural network. In some other embodiments, there may be many hidden layers. Furthermore, the neural network can be in some other types of topology, such as Convolution Neural Network (CNN) as discussed above, Recurrent Neural Network (RNN), and so forth.

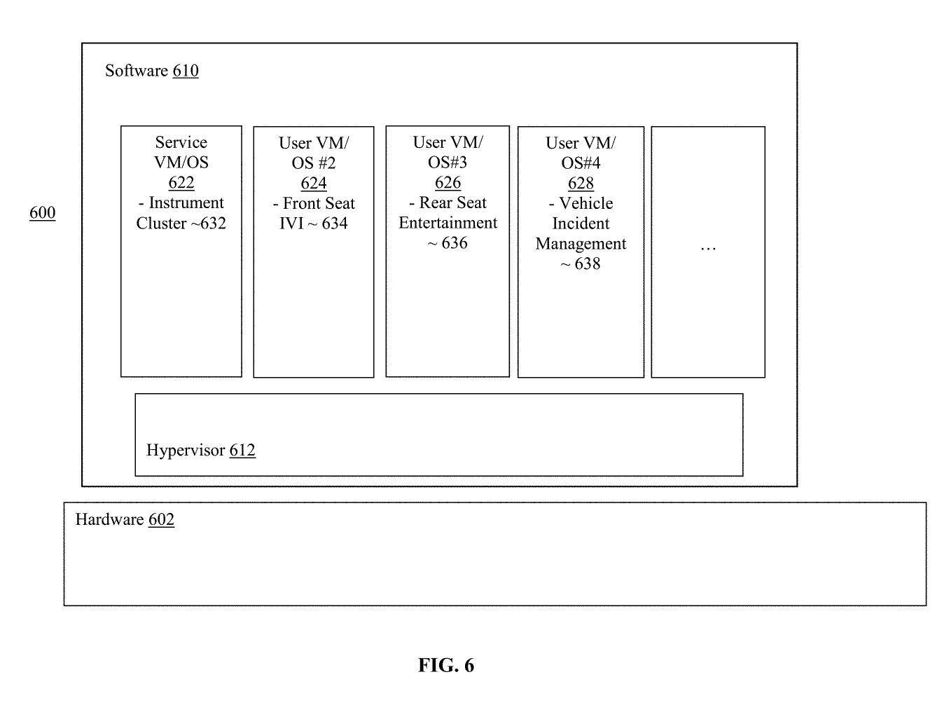

FIG. 6 illustrates an exemplary software component view of a smart transport device incident management system, according to various embodiments. A software component view of the smart transport device vehicle incident management (VIM) system, according to various embodiments, is illustrated. As shown, for the embodiments, VIM system 600, which could be VIM system 400, includes hardware 602 and software 610. Software 610 includes hypervisor 612 hosting a number of virtual machines (VMs) 622-628. Hypervisor 612 is configured to host execution of VMs 622-628. The VMs 622-628 include a service VM 622 and a number of user VMs 624-628. Service machine 622 includes a service OS hosting execution of a number of instrument cluster applications 632. User VMs 624-628 may include a first user VM 624 having a first user OS hosting execution of front seat infotainment applications 634, a second user VM 626 having a second user OS hosting execution of rear seat infotainment applications 636, a third user VM 628 having a third user OS hosting execution of a smart transport device incident management system, and so forth.

Except for smart transport device incident management technology 450 of the present disclosure, elements 612-638 of software 610 may be any one of a number of these elements known in the art. For example, hypervisor 612 may be any one of a number of hypervisors known in the art, such as KVM, an open source hypervisor, Xen, available from Citrix Inc, of Fort Lauderdale, Fla., or VMware, available from VMware Inc of Palo Alto, Calif., and so forth. Similarly, service OS of service VM 622 and user OS of user VMs 624-628 may be any one of a number of OS known in the art, such as Linux, available e.g., from Red Hat Enterprise of Raliegh, N.C., or Android, available from Google of Mountain View, Calif.

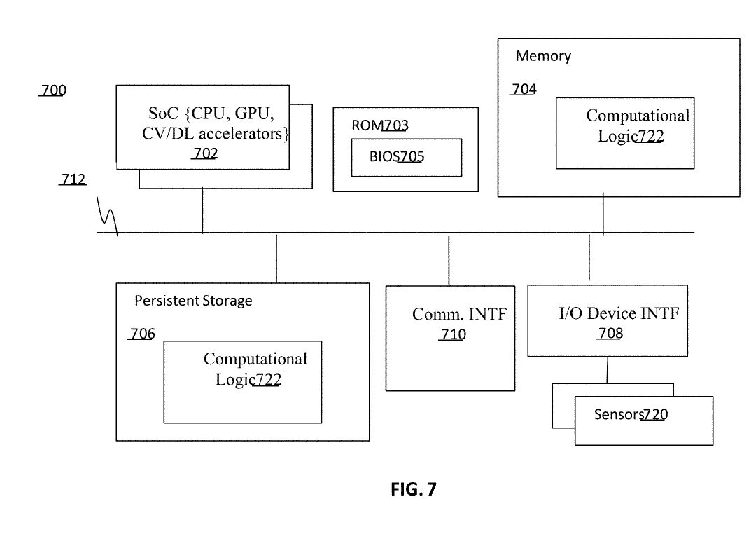

FIG. 7 illustrates an exemplary hardware component view of a smart transport device incident management system, according to various embodiments. As shown, computing platform 700, which may be hardware 602 of FIG. 6, may include one or more system-on-chips (SoCs) 702, ROM 703 and system memory 704. Each SoCs 702 may include one or more processor cores (CPUs), one or more graphics processor units (GPUs), one or more accelerators, such as computer vision (CV) and/or deep learning (DL) accelerators. ROM 703 may include basic input/output system services (BIOS) 705. CPUs, GPUs, and CV/DL accelerators may be any one of a number of these elements known in the art. Similarly, ROM 703 and BIOS 705 may be any one of a number of ROM and BIOS known in the art, and system memory 704 may be any one of a number of volatile storage known in the art.

Additionally, computing platform 700 may include persistent storage devices 706. Example of persistent storage devices 706 may include, but are not limited to, flash drives, hard drives, compact disc read-only memory (CD-ROM) and so forth. Further, computing platform 700 may include one or more input/output (I/O) interfaces 708 to interface with one or more I/O devices, such as sensors 720, as well as but not limited to display(s), keyboard(s), cursor control(s) and so forth. Computing platform 700 may also include one or more communication interfaces 710 (such as network interface cards, modems and so forth). Communication devices may include any number of communication and I/O devices known in the art. Examples of communication devices may include, but are not limited to, networking interfaces for Bluetooth®, Near Field Communication (NFC), WiFi, Cellular communication (such as LTE 4G/5G) and so forth. The elements may be coupled to each other via system bus 712, which may represent one or more buses. In the case of multiple buses, they may be bridged by one or more bus bridges (not shown).

Each of these elements may perform its conventional functions known in the art. In particular, ROM 703 may include BIOS 705 having a boot loader. System memory 704 and mass storage devices 706 may be employed to store a working copy and a permanent copy of the programming instructions implementing the operations associated with hypervisor 612, service/user OS of service/user VM 622-628, and components of VIM technology 450 (such as occupant condition assessment subsystems, smart transport device assessment subsystem, external environment condition assessment subsystem, and so forth), collectively referred to as computational logic. The various elements may be implemented by assembler instructions supported by processor core(s) of SoCs 702 or high-level languages, such as, for example, C, that can be compiled into such instructions.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 8 illustrates an example computer-readable non-transitory storage medium that may be suitable for use to store instructions that cause an apparatus, in response to execution of the instructions by the apparatus, to practice selected aspects of the present disclosure.

FIG. 8 illustrates an exemplary computer device 800 that may employ aspects of the apparatuses and/or methods described herein in accordance with various embodiments. It will be appreciated FIG. 8 contains some items similar to ones called out in other figures and they may be the same items, or simply similar, and they may operate the same or they may operate internally very different yet provide a similar input/output system. As shown, computer device 800 may include a number of components, such as one or more processor(s) 802 (one shown) and at least one communication chip(s) 804. In various embodiments, the one or more processor(s) 802 each may include one or more processor cores. In various embodiments, the at least one communication chip 804 may be physically and electrically coupled to the one or more processor(s) 802. In further implementations, the communication chip(s) 804 may be part of the one or more processor(s) 802. In various embodiments, computer device 800 may include printed circuit board (PCB) 806. For these embodiments, the one or more processor(s) 802 and communication chip(s) 804 may be disposed thereon. In alternate embodiments, the various components may be coupled without the employment of PCB 806.

Depending on its applications, computer device 800 may include other components that may or may not be physically and electrically coupled to the PCB 806. These other components include, but are not limited to, memory controller 808, volatile memory (e.g., dynamic random access memory (DRAM) 810), non-volatile memory such as read only memory (ROM) 812, flash memory 814, storage device 816 (e.g., a hard-disk drive (HDD)), an I/O controller 818, a digital signal processor 820, a crypto processor 822, a graphics processor 824 (e.g., a graphics processing unit (GPU) or other circuitry for performing graphics), one or more antenna 826, a display which may be or work in conjunction with a touch screen display 828, a touch screen controller 830, a battery 832, an audio codec (not shown), a video codec (not shown), a positioning system such as a global positioning system (GPS) device 834 (it will be appreciated other location technology may be used), a compass 836, an accelerometer (not shown), a gyroscope (not shown), a speaker 838, a camera 840, and other mass storage devices (such as hard disk drive, a solid state drive, compact disk (CD), digital versatile disk (DVD)) (not shown), and so forth.

As used herein, the term “circuitry” or “circuit” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, processor, microprocessor, programmable gate array (PGA), field programmable gate array (FPGA), digital signal processor (DSP) and/or other suitable components that provide the described functionality. Note while this disclosure may refer to a processor in the singular, this is for expository convenience only, and one skilled in the art will appreciate multiple processors, processors with multiple cores, virtual processors, etc., may be employed to perform the disclosed embodiments.

In some embodiments, the one or more processor(s) 802, flash memory 814, and/or storage device 816 may include associated firmware (not shown) storing programming instructions configured to enable computer device 800, in response to execution of the programming instructions by one or more processor(s) 802, to practice all or selected aspects of the methods described herein. In various embodiments, these aspects may additionally be or alternatively be implemented using hardware separate from the one or more processor(s) 802, flash memory 814, or storage device 816. In one embodiment, memory, such as flash memory 814 or other memory in the computer device, is or may include a memory device that is a block or byte addressable memory device, such as those based on NAND, NOR, Phase Change Memory (PCM), nanowire memory, and other technologies including future generation nonvolatile devices, such as a three dimensional crosspoint memory device, or other byte addressable write-in-place nonvolatile memory devices. In one embodiment, the memory device may be or may include memory devices that use chalcogenide glass, multi-threshold level NAND flash memory, NOR flash memory, single or multi-level PCM, a resistive memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product.

In various embodiments, one or more components of the computer device 800 may implement an embodiment of FIG. 1 items 102, 104, 110, 122, 126, FIG. 3 items 302-316, FIG. 4 items 4052, 4053, 4060, etc. Thus for example processor 802 could be the FIG. 7 SoC 702 communicating with memory 810 though memory controller 808. In some embodiments, I/O controller 818 may interface with one or more external devices to receive a data. Additionally, or alternatively, the external devices may be used to receive a data signal transmitted between components of the computer device 800.

The communication chip(s) 804 may enable wired and/or wireless communications for the transfer of data to and from the computer device 800. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip(s) may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device may include a plurality of communication chips 804. For instance, a first communication chip(s) may be dedicated to shorter range wireless communications such as Wi-Fi and Bluetooth, or other standard or proprietary shorter range communication technology, and a second communication chip 804 may be dedicated to longer range wireless communications such as GPS, EDGE, GPRS, CDMA, WiMAX, LTE, Ev-DO, and others.

The communication chip(s) may implement any number of standards, protocols, and/or technologies datacenters typically use, such as networking technology providing high-speed low latency communication. Computer device 800 may support any infrastructures, protocols and technology identified here, and since new high-speed technology is always being implemented, it will be appreciated by one skilled in the art that the computer device is expected to support equivalents currently known or technology implemented in future.

In various implementations, the computer device 800 may be a laptop, a netbook, a notebook, an ultrabook, a smartphone, a computer tablet, a personal digital assistant (PDA), an ultra-mobile PC, a mobile phone, a desktop computer, a server, a printer, a scanner, a monitor, a set-top box, an entertainment control unit (e.g., a gaming console, automotive entertainment unit, etc.), a digital camera, an appliance, a portable music player, or a digital video recorder, or a transportation device (e.g., any motorized or manual device such as a bicycle, motorcycle, automobile, taxi, train, plane, drone, rocket, robot, smart transport device, etc.). It will be appreciated computer device 800 is intended to be any electronic device that processes data.

FIG. 9 illustrates an exemplary computer-readable storage medium 900 having instructions for practicing various embodiments discussed herein. The storage medium may be non-transitory and may include one or more defined regions that may include a number of programming instructions 904. Programming instructions 904 may be configured to enable a device, e.g., FIG. 1 Al 122, or FIG. 7 computing platform 700, in response to execution of the programming instructions, to implement (aspects of) smart space monitoring and predicting responses to events, incidents, accidents, etc., or hypervisor 412, service/user OS of service/user VM 422-428, and components of VIM technology 450 (such as a main system controller, occupant condition assessment subsystems, smart transport device assessment subsystem, external environment condition assessment subsystem, and so forth). In alternate embodiments, programming instructions 904 may be disposed on multiple computer-readable non-transitory storage media 902. In still other embodiments, programming instructions 904 may be disposed on computer-readable transitory storage media 902, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process. The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

The storage medium may be transitory, non-transitory or a combination of transitory and non-transitory media, and the medium may be suitable for use to store instructions that cause an apparatus, machine or other device, in response to execution of the instructions by the apparatus, to practice selected aspects of the present disclosure. As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium.

The following are examples of exemplary embodiments and combinations of embodiments. It will be appreciated one example may depend from multiple examples that in turn also depend from multiple embodiments. It is intended for all combinations of examples to be possible, including multiply-dependent examples. To the extent a combination inadvertently is contradictory, all other combinations are intended to remain valid. Each possible traversal through the example dependency hierarchy is intended to be an exemplary

Example 1 may be a system of a smart space including at least a first sensor associated with a first item in the smart space, an agent, and a second sensor associated with a neural network to monitor the smart space, the neural network having a training being at least in part self-trained by data from the second sensor, the system comprising: the first sensor to indicate a first status of the first item; the second sensor to provide a representation of the smart space; and the agent having an agent status corresponding to agent activity over time; wherein the neural network to receive as input the first status, the representation of the smart space, and the agent status, and to predict based at least in part on the input and the training whether an incident occurred, and whether the agent status corresponds to a response to the incident.

Example 2 may be example 1, wherein the neural network is able to determine the agent status based at least in part on analysis by the neural network of a feedback signal to the neural network including a selected one or both of: the representation of the smart space, or a third sensor associated with the agent.

Example 3 may be example 1 or example 2, further comprising an alert corresponding to the incident; wherein the neural network to clear the alert if it predicts the response to the alert.

Example 4 may be example 3, wherein the neural network is implemented across a set of one or more machines storing a model based at least in part on the training, the neural network to predict, based at least in part on the model, whether the response is an appropriate response to the alert, and if so, to clear the alert.

Example 5 may be example 1 or any of examples 2-4, in which the agent may be a person or an item, and the neural network comprises: an item recognition component to recognize items in the smart space; a person recognition component to recognize people in the smart space; a map component to map recognized items and people; and an inference component to predict future activity within the smart space; wherein the neural network to predict, based at least in part on output from the inference component, if the agent activity is an appropriate response to the incident.

Example 6 may be example 1 or any of examples 2-5, wherein the first sensor is associated with an Internet of Things (IoT) device, and a second sensor is associated with an IoT device of the agent, wherein the agent status is determined based at least in part on data provided by the second sensor.

Example 7 may be example 1 or any of examples 2-6, wherein the neural network to recognize an interaction between the agent and the first item, and the neural network to predict if the agent activity is an appropriate response to the incident based at least in part on the interaction.

Example 8 may be example 7, wherein the neural network to issue an alert if the neural network to predict if the agent activity fails to provide the appropriate response to the incident.

Example 9 may be example 1 or any of examples 2-8, wherein the neural network maps the smart space based on sensors proximate to the smart space, and based on the representation of the smart space.

Example 10 may be a method for neural network to control an alert to task an agent to respond to an incident in a smart space, comprising: training the neural network based at least in part on a first sensor providing a representation of the smart space, the training including monitoring the smart space, predicting an activity in the smart space, and confirming whether the predicted activity corresponds to an actual activity; receiving a signal indicating an incident occurred in the smart space; operating an inference model to determine if a response is needed to the incident; activating the alert to task the agent to respond to the incident; monitoring the representation of the smart space and identifying agent activity; and determining if the agent activity is a response to the incident.

Example 11 may be example 10, wherein: the training includes establishing a baseline model identifying at least items and people in the smart space, and the items and people have associated attributes including at least a location within the smart space.

Example 12 may be example 10 or example 11, wherein the determining comprises: predicting future movement of the agent over a time period; comparing the predicted future movement to a learned appropriate movement taken responsive to the incident; and determining whether the predicted future movement corresponds to the learned appropriate movement.

Example 13 may be example 10 or any of examples 11-12, further comprising: determining the agent activity is not the response to the incident; and escalating the alert.

Example 14 may be example 10 or any of examples 11-13, wherein the neural network is self-trained through monitoring sensors within the smart space and the representation of the smart space, the method comprising: developing an inference model based at least in part on identifying common incidents in the smart space, and typical responses to the common incidents in the smart space; and determining if the agent activity is the response to the incident based at least in part on applying the inference model to the agent activity to recognize a correspondence with typical responses.

Example 15 may be example 10 or any of examples 11-14, wherein the neural network provides instructions to the agent, and the agent is a selected one of: a first person, a first semi-autonomous smart transport device, or a second person inside a second smart transport device.

Example 16 may be example 10 or any of examples 11-15, in which the agent may be a person or an item, the method further comprises: recognizing items in the smart space; recognizing people in the smart space; mapping recognized items and people; applying an inference model to predict future activity associated with the smart space; and predicting, based at least in part on applying the inference model, if the agent activity is an appropriate response to the incident.

Example 17 may be example 16 or any of examples 10-15, wherein the signal is received from a first sensor associated with an Internet of Things (IoT) device, and a second sensor is associated with an IoT device of the agent, wherein the agent activity is also determined based in part on the second sensor.

Example 18 may be example 10 or any of examples 11-17, in which the agent activity includes an interaction between the agent and the first item, the method further comprising the neural network: recognizing the interaction between the agent and the first item; determining the agent activity is the response to the incident; predicting whether the response is an appropriate response to the incident; and issuing instructions to the agent responsive to predicting the response fails to provide the appropriate response.

Example 19 may be one or more non-transitory computer-readable media having instructions for a neural network to control an alert to task an agent to respond to an incident in a smart space, the instructions to provide for: training the neural network based at least in part on a first sensor providing a representation of the smart space, the training including monitoring the smart space, predicting an activity in the smart space, and confirming whether the predicted activity corresponds to an actual activity; receiving a signal indicating an incident occurred in the smart space; operating an inference model to determine if a response is needed to the incident; activating the alert to task the agent to respond to the incident; monitoring the representation of the smart space and identifying agent activity; and determining if the agent activity is a response to the incident.

Example 20 may be example 19, wherein the instructions for the training further including instructions to provide for establishing a baseline model identifying at least items and people in the smart space, and wherein the media further includes instructions for associating attributes with items and people, the attributes including at least a location within the smart space.

Example 21 may be example 19 or example 20, the instructions for the determining further including instructions to provide for: predicting future movement of the agent over a time period; comparing the predicted future movement to a learned appropriate movement taken responsive to the incident; and determining whether the predicted future movement corresponds to the learned appropriate movement.

Example 22 may be example 21 or examples 19-20, the instructions further including instructions for operation of the neural network, the instructions to provide for: self-training the neural network through monitoring sensors within the smart space and the representation of the smart space; developing an inference model based at least in part on identifying common incidents in the smart space, and typical responses to the common incidents in the smart space; and determining if the agent activity is the response to the incident based at least in part on applying the inference model to the agent activity to recognize a correspondence with typical responses.

Example 23 may be example 19, or examples 20-22, the instructions including instructions to provide for: determining a classification for the agent including identifying if the agent is a first person, a semi-autonomous smart transport device, or a second person inside a second smart transport device; and providing instructions to the agent in accord with the classification.

Example 24 may be example 19, or examples 20-23, in which the agent may be a person or an item, the instructions further including instructions to provide for: recognizing items in the smart space; recognizing people in the smart space; mapping recognized items and people; applying an inference model to predict future activity associated with the smart space; and predicting, based at least in part on applying the inference model, if the agent activity is an appropriate response to the incident.

Example 25 may be example 24 or examples 20-23, the instructions including further instructions to provide for: identifying the agent activity includes an interaction between the agent and the first item; recognizing the interaction between the agent and the first item; determining the agent activity is the response to the incident; predicting whether the response is an appropriate response to the incident; and issuing instructions to the agent responsive to predicting the response fails to provide the appropriate response.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A system of a smart space including at least a first sensor associated with a first item in the smart space, an agent, and a second sensor associated with a neural network to monitor the smart space, the neural network having a training being at least in part self-trained by data from the second sensor, the system comprising:
the first sensor to indicate a first status of the first item;
the second sensor to provide a representation of the smart space; and
the agent having an agent status corresponding to agent activity over time;
wherein the neural network to receive as input the first status, the representation of the smart space, and the agent status, and to predict based at least in part on the input and the training whether an incident occurred, and whether the agent status corresponds to a response to the incident.

2. The system of claim 1, wherein the neural network is able to determine the agent status based at least in part on analysis by the neural network of a feedback signal to the neural network including a selected one or both of: the representation of the smart space, or a third sensor associated with the agent.

3. The system of claim 1, further comprising an alert corresponding to the incident; wherein the neural network to clear the alert if it predicts the response to the alert.

4. The system of claim 3, wherein the neural network is implemented across a set of one or more machines storing a model based at least in part on the training, the neural network to predict, based at least in part on the model, whether the response is an appropriate response to the alert, and if so, to clear the alert.

5. The system of claim 1, in which the agent may be a person or an item, and the neural network comprises:
an item recognition component to recognize items in the smart space;
a person recognition component to recognize people in the smart space;
a map component to map recognized items and people; and
an inference component to predict future activity within the smart space;
wherein the neural network to predict, based at least in part on output from the inference component, if the agent activity is an appropriate response to the incident.

6. The system of claim 1, wherein the first sensor is associated with an Internet of Things (IoT) device, and a second sensor is associated with an IoT device of the agent, wherein the agent status is determined based at least in part on data provided by the second sensor.

7. The system of claim 1, wherein the neural network to recognize an interaction between the agent and the first item, and the neural network to predict if the agent activity is an appropriate response to the incident based at least in part on the interaction.

8. The system of claim 7, wherein the neural network to issue an alert if the neural network to predict if the agent activity fails to provide the appropriate response to the incident.

9. The system of claim 1 wherein the neural network maps the smart space based on sensors proximate to the smart space, and based on the representation of the smart space.

10. A method for neural network to control an alert to task an agent to respond to an incident in a smart space, comprising:
training the neural network based at least in part on a first sensor providing a representation of the smart space, the training including monitoring the smart space, predicting an activity in the smart space, and confirming whether the predicted activity corresponds to an actual activity;
receiving a signal indicating an incident occurred in the smart space;
operating an inference model to determine if a response is needed to the incident;
activating the alert to task the agent to respond to the incident;
monitoring the representation of the smart space and identifying agent activity; and
determining if the agent activity is a response to the incident.

11. The neural network of claim 10, wherein: the training includes establishing a baseline model identifying at least items and people in the smart space, and the items and people have associated attributes including at least a location within the smart space.

12. The method of claim 10, wherein the determining comprises:
predicting future movement of the agent over a time period;
comparing the predicted future movement to a learned appropriate movement taken responsive to the incident; and
determining whether the predicted future movement corresponds to the learned appropriate movement.

13. The method of claim 10, further comprising:
determining the agent activity is not the response to the incident; and
escalating the alert.

14. The method of claim 10 wherein the neural network is self-trained through monitoring sensors within the smart space and the representation of the smart space, the method comprising:
developing an inference model based at least in part on identifying common incidents in the smart space, and typical responses to the common incidents in the smart space; and
determining if the agent activity is the response to the incident based at least in part on applying the inference model to the agent activity to recognize a correspondence with typical responses.

15. The method of claim 10, wherein the neural network provides instructions to the agent, and the agent is a selected one of: a first person, a first semi-autonomous smart transport device, or a second person inside a second smart transport device.

16. The method of claim 10, in which the agent may be a person or an item, the method further comprises:
recognizing items in the smart space;
recognizing people in the smart space;
mapping recognized items and people;
applying an inference model to predict future activity associated with the smart space; and
predicting, based at least in part on applying the inference model, if the agent activity is an appropriate response to the incident.

17. The method of claim 16, wherein the signal is received from a first sensor associated with an Internet of Things (IoT) device, and a second sensor is associated with an IoT device of the agent, wherein the agent activity is also determined based in part on the second sensor.

18. The method of claim 10, in which the agent activity includes an interaction between the agent and the first item, the method further comprising the neural network:
recognizing the interaction between the agent and the first item;
determining the agent activity is the response to the incident;
predicting whether the response is an appropriate response to the incident; and
issuing instructions to the agent responsive to predicting the response fails to provide the appropriate response.

19. One or more non-transitory computer-readable media having instructions for a neural network to control an alert to task an agent to respond to an incident in a smart space, the instructions to provide for:
training the neural network based at least in part on a first sensor providing a representation of the smart space, the training including monitoring the smart space, predicting an activity in the smart space, and confirming whether the predicted activity corresponds to an actual activity;
receiving a signal indicating an incident occurred in the smart space;
operating an inference model to determine if a response is needed to the incident;
activating the alert to task the agent to respond to the incident;
monitoring the representation of the smart space and identifying agent activity; and
determining if the agent activity is a response to the incident.

20. The media of claim 19, wherein the instructions for the training further including instructions to provide for establishing a baseline model identifying at least items and people in the smart space, and wherein the media further includes instructions for associating attributes with items and people, the attributes including at least a location within the smart space.

21. The media of claim 19, the instructions for the determining further including instructions to provide for:
predicting future movement of the agent over a time period;
comparing the predicted future movement to a learned appropriate movement taken responsive to the incident; and
determining whether the predicted future movement corresponds to the learned appropriate movement.

22. The media of claim 21, the instructions further including instructions for operation of the neural network, the instructions to provide for:
self-training the neural network through monitoring sensors within the smart space and the representation of the smart space;
developing an inference model based at least in part on identifying common incidents in the smart space, and typical responses to the common incidents in the smart space; and
determining if the agent activity is the response to the incident based at least in part on applying the inference model to the agent activity to recognize a correspondence with typical responses.

23. The media of claim 19, the instructions including instructions to provide for:
determining a classification for the agent including identifying if the agent is a first person, a semi-autonomous smart transport device, or a second person inside a second smart transport device; and
providing instructions to the agent in accord with the classification.

24. The media of claim 19, in which the agent may be a person or an item, the instructions further including instructions to provide for:
recognizing items in the smart space;
recognizing people in the smart space;
mapping recognized items and people;
applying an inference model to predict future activity associated with the smart space; and
predicting, based at least in part on applying the inference model, if the agent activity is an appropriate response to the incident.

25. The media of claim 24, the instructions including further instructions to provide for:
identifying the agent activity includes an interaction between the agent and the first item;
recognizing the interaction between the agent and the first item;
determining the agent activity is the response to the incident;
predicting whether the response is an appropriate response to the incident; and
issuing instructions to the agent responsive to predicting the response fails to provide the appropriate response.
